(19) United States
(12) Patent Application Publication
(10) Pub. No.: US 2006/0101412 A1
(43) Pub. Date: May 11, 2006

(54) Method to bridge between unmanaged code and managed code

(75) Inventors: Boaz Lev, Copenhagen (DK); Shahar Prish, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 10/985,513

(22) Filed: Nov. 10, 2004

(51) Int. Cl. G06F 9/44

(52) U.S. Cl. 717/127

(57) ABSTRACT

A method of executing managed code in unmanaged host is disclosed. The method may require loading a runtime bridge in the unmanaged host, passing a callback from the unmanaged host to the runtime bridge, loading specified managed code assembly into the runtime bridge (under direction of the unmanaged host), executing a desired method found in the managed code assembly in the runtime bridge, passing the results of the method called in the managed code assembly to the runtime bridge, marshalling the results of the method called in the managed code assembly in the runtime bridge such that the results can be used by the unmanaged host and passing the marshaled results of the method called in the managed code assembly to the unmanaged host. The method may also require allowing the managed code to call back into the unmanaged code using the callback through the runtime bridge for the execution of a method in the unmanaged code as if the call had originated in the context of the unmanaged host, having the runtime bridge marshal data received from the unmanaged code and passing the marshaled data through the runtime bridge to the managed code.

### BACKGROUND

Since the creation of computers, a significant amount of computer software code has been written and as computers have evolved, it has become desirable to operate code in a more predictable manner. For example, it may be desirable to have different computers using different operating systems be able to use the same remote programs by knowing in advance how remote programs expect data, what command are available, etc. One such manner is referred to as “managed code” in which a sort of contract of cooperation is created between natively executing code and the runtime. However, adapting all existing code to be managed code would involve a significant cost. In addition, previous methods of operating unmanaged code in a managed code environment have involved using component object model (“COM”) objects which can be slow and limited in function.

### SUMMARY

A method of executing managed code in unmanaged host is disclosed. The method may require loading a runtime bridge in the unmanaged host, passing a callback from the unmanaged host to the runtime bridge, loading specified managed code assembly into the runtime bridge (under direction of the unmanaged host), executing a desired method found in the managed code assembly in the runtime bridge, passing the results of the method called in the managed code assembly to the runtime bridge, marshalling the results of the method called in the managed code assembly in the runtime bridge such that the results can be used by the unmanaged host and passing the marshaled results of the method called in the managed code assembly to the unmanaged host.

According to another aspect of the invention, the method may require reflecting over the types in the managed code assembly in the runtime bridge and instantiating classes found through reflection. Further, the method may require loading a common language routine in the runtime bridge. Finally, the method may require allowing the managed code to call back into the unmanaged code using the callback through the runtime bridge for the execution of a method in the unmanaged code as if the call had originated in the context of the unmanaged host, having the runtime bridge marshal data received from the unmanaged code and passing the marshaled data through the runtime bridge to the managed code.

Also disclosed is a memory having a computer program stored therein, where the computer program is capable of being used in connection with a computing apparatus, where the memory has several portions and where a memory portion is physically configured in accordance with computer program instructions that would cause the computing apparatus to load a runtime bridge in an unmanaged host, an additional memory portion physically configured in accordance with computer program instructions that would cause the computing apparatus to pass a callback from the unmanaged host to the runtime bridge, an additional memory portion physically configured in accordance with computer program instructions that would cause the computing apparatus to load specified managed code assembly into the runtime bridge (under direction of the unmanaged host), an additional memory portion physically configured in accordance with computer program instructions that would cause the computing apparatus to execute a desired method found in the managed code assembly in the runtime bridge, an additional memory portion physically configured in accordance with computer program instructions that would cause the computing apparatus to pass the results of the method called in the managed code assembly to the runtime bridge; an additional memory portion physically configured in accordance with computer program instructions that would cause the computing apparatus to marshal the results of the method called in the managed code assembly in the runtime bridge such that the results can be used by the unmanaged host and an additional memory portion physically configured in accordance with computer program instructions that would cause the computing apparatus to pass the marshaled results of the method called in the managed code assembly to the unmanaged host. The memory also may have an additional memory portion physically configured in accordance with computer program instructions that would cause the computing apparatus to an additional memory portion physically configured in accordance with computer program instructions that would cause the computing apparatus to reflect over the types in the managed code assembly in the runtime bridge, instantiate classes found through reflection and load a common language routine in the runtime bridge. There as may be an additional memory portion physically configured in accordance with computer program instructions that would cause the computing apparatus to allowing the managed code to call back into the unmanaged code using the callback through the runtime bridge for the execution of a method in the unmanaged code as if the call had originated in the context of the unmanaged host, an additional memory portion physically configured in accordance with computer program instructions that would cause the computing apparatus to have the runtime bridge marshal data received from the unmanaged code and an additional memory portion physically configured in accordance with computer program instructions that would cause the computing apparatus to pass the marshaled data through the runtime bridge to the managed code.

Also disclosed is a computing apparatus, that contains a display unit that is capable of generating video images, an input device, a processing apparatus operatively coupled to said display unit and said input device, said processing apparatus comprising a processor and a memory operatively coupled to said processor and a network interface connected to a network and to the processing apparatus. The processing apparatus may be programmed to load a runtime bridge in an unmanaged host, pass a callback from the unmanaged host to the runtime bridge, load specified managed code assembly into the runtime bridge (under direction of the unmanaged host), execute a desired method found in the managed code assembly in the runtime bridge, pass the results of the method called in the managed code assembly to the runtime bridge, marshal the results of the method called in the managed code assembly in the runtime bridge such that the results can be used by the unmanaged host and pass the marshaled results of the method called in the managed code assembly to the unmanaged host. The computing apparatus may also be programmed reflect over the types in the managed code assembly in the runtime bridge and to instantiate classes found through reflection and to load a common language routine in the runtime bridge. In addition, the processing apparatus may be programmed to allow the managed code to call back into the unmanaged code using the callback through the runtime bridge for the execution of a method in the unmanaged code as if the call had originated in the context of the unmanaged host, have the runtime bridge marshal data received from the unmanaged code and pass the marshaled data through the runtime bridge to the managed code.

### BRIEF DESCRIPTION OF THE DRAWINGS

FIG. 1 is a block diagram of an embodiment of a computing apparatus system in accordance with the claims;

FIG. 2 is a block diagram of a method in accordance with the claims; and

FIG. 3 is a block diagram of a method in accordance with the claims.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

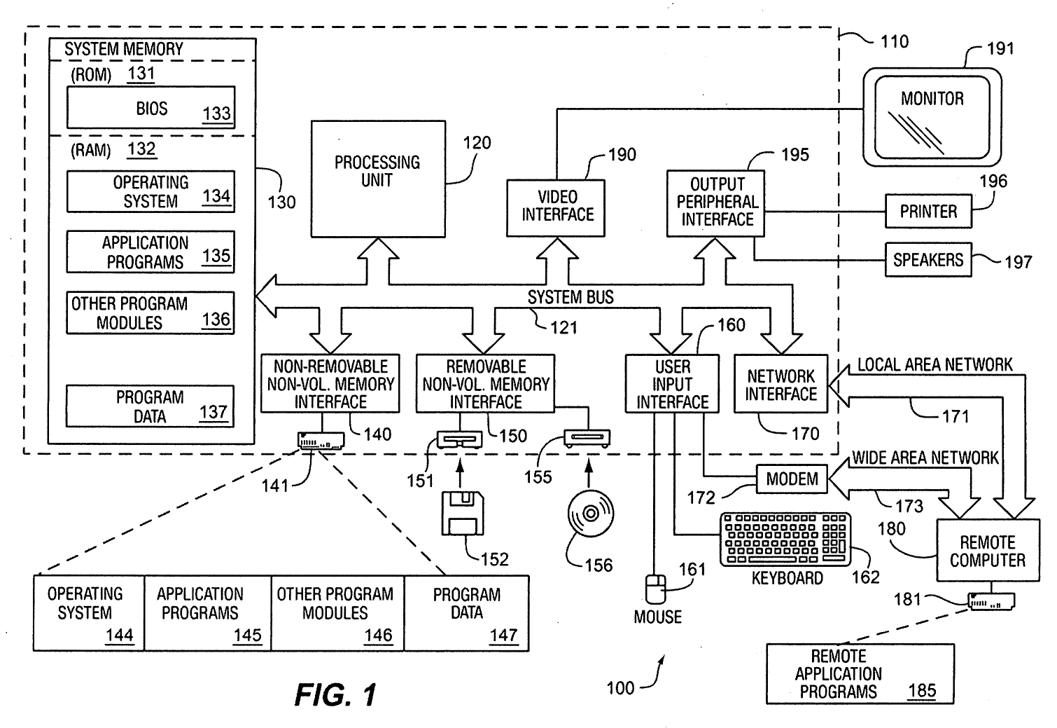

FIG. 1 illustrates an example of a suitable computing system environment 100 on which the claimed method and programmed memory and apparatus may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The claimed methods, programmed memory and apparatus are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The claimed methods, apparatus and programmed memory may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the claimed methods, apparatus and programmed memory includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Managed Code

Managed code may be code that has its execution managed by a common runtime language such as the NET Framework Common Language Runtime (CLR). Managed code may refer to a contract of cooperation between natively executing code and the runtime. This contract may specify that at any point of execution, the runtime may stop an executing CPU and retrieve information specific to the current CPU instruction address. Information that may be query-able generally pertains to runtime state, such as register or stack memory contents.

The necessary information may be encoded in an Intermediate Language (IL) and associated metadata, or symbolic information that describes all of the entry points and the constructs exposed in the IL (e.g., methods, properties) and their characteristics. The Common Language Infrastructure (CLI) Standard (which the CLR is the primary commercial implementation) describes how the information is to be encoded, and programming languages that target the runtime emit the correct encoding. All a developer has to know is that any of the languages that target the runtime produce managed code emitted as portable executable (“PE”) files that contain IL and metadata. There are many such languages to choose from, since there are nearly 20 different languages provided by third parties—everything from COBOL to Camel—in addition to C#, J#, VB .Net, Jscript .Net, and C++ from Microsoft.

Before the code is run, the IL may be compiled into native executable code. Because this compilation happens in the managed execution environment (or, more correctly, by a runtime-aware compiler that knows how to target the managed execution environment), the managed execution environment may make guarantees about what the code is going to do. It may insert traps and appropriate garbage collection hooks, exception handling, type safety, array bounds and index checking, and so forth. For example, such a compiler may make sure to lay out stack frames and everything just right so that the garbage collector can run in the background on a separate thread, constantly walking the active call stack, finding all the roots and chasing down all the live objects. In addition, because the IL has a notion of type safety, the execution engine will maintain the guarantee of type safety, eliminating a whole class of programming mistakes that often lead to security holes.

### Unmanaged Code

Unmanaged executable files may be described as a binary image, x86 code, loaded into memory. The program counter may be put there and that's the last the operating system knows. There may be protections in place around memory management and port I/O and so forth, but the system doesn't actually know what the application is doing. Therefore, unmanaged executable files can't make any guarantees about what happens when the application runs.

### Bridges

A bridge may allow one piece of software communicate with another piece of software. Bridges may be necessary when software uses different data arrangements and cannot talk directly with each other. In other instances, a first piece of software may be purposely designed such that other pieces of software cannot speak directly to the first piece of software. A bridge may be designed to be placed between the two pieces of software. The bridge may accept data from a first piece of software and arrange the data into a form that will be understood and accepted by a second piece of software and vice versa.

One example of a bridge may be a bridge that operates between managed code and unmanaged code. It may not be desirable to completely disregard unmanaged code while there may be a desire to operate in a managed code environment. A method of operating managed code in an unmanaged host by using a runtime bridge may be useful.

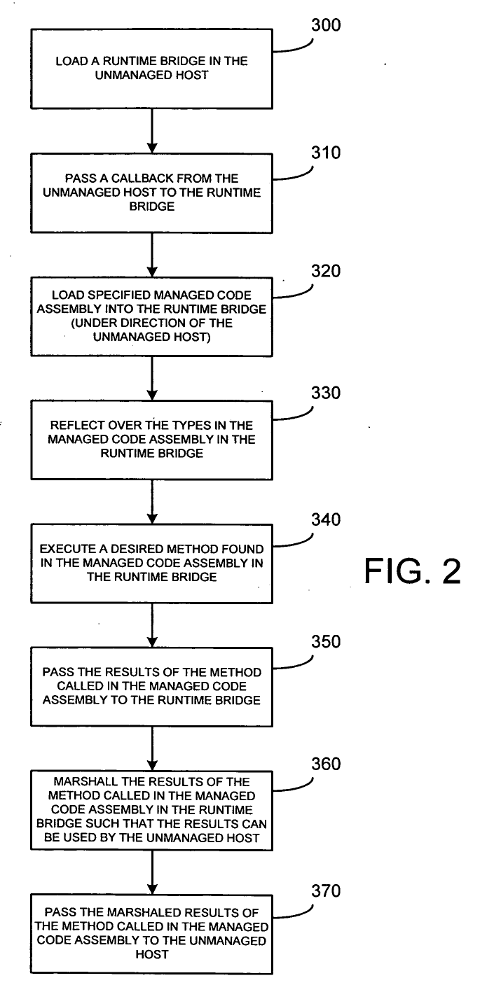

FIG. 2 is an illustration of a method using a bridge that may allow unmanaged code to be used in a managed code environment. At a block 300, a method may load a runtime bridge in an unmanaged host. The term “runtime bridge” is used to give the reader a sense of the activity occurring but may not be a particular term of art. The runtime bridge may include loading a common language routine (“CLR”) into the bridge. At block 310, a callback may be passed from the unmanaged host to the runtime bridge. A callback may be a scheme used in event-driven programs where the program registers a subroutine (a “callback handler”) to handle a certain event. The program does not call the handler directly but when the event occurs, the run-time system calls the handler, usually passing it arguments to describe the event.

At block 320, a specified managed code assembly may be loaded into the runtime bridge (under direction of the unmanaged host).

At block 330, a desired method found in the managed code assembly may be executed in the runtime bridge. At block 340, the results of the method called in the managed code assembly may be passed to the runtime bridge. At block 350; the results of the method called in the managed code assembly in the runtime bridge may be marshaled such that the results can be used by the unmanaged host. At block 360, the marshaled results of the method called in the managed code assembly may be passed to the unmanaged host.

The types in the managed code assembly may undergo reflection in the runtime bridge. Reflection allows a user to do the following at runtime: view type information, examine the structure of specific types, dynamically load and use types, and access custom attributes. The type class is the main class a user will use when implementing Reflection in an application. A user can use the type object's methods, fields, properties and nested classes to find out most information needed about any type. Reflection is highly useful if a users wants to find out if a local or remote component supports specific functionality. For example, if a user wants to use another developer's component, but does not know if the component implements a specific method, the user can examine the component using the MethodInfo class to search for the method the user wishes to execute. The most commonly used reflection classes include: the Assembly, Module, ConstructorInfo, MethodInfo, FieldInfo, EventInfo, PropertyInfo, and ParameterInfo classes. In summary, a user can use Reflection to examine the programming types and constructs in an applications and determine the functionality, structure, or usage. In addition, any classes that are found through reflection may be instantiated.

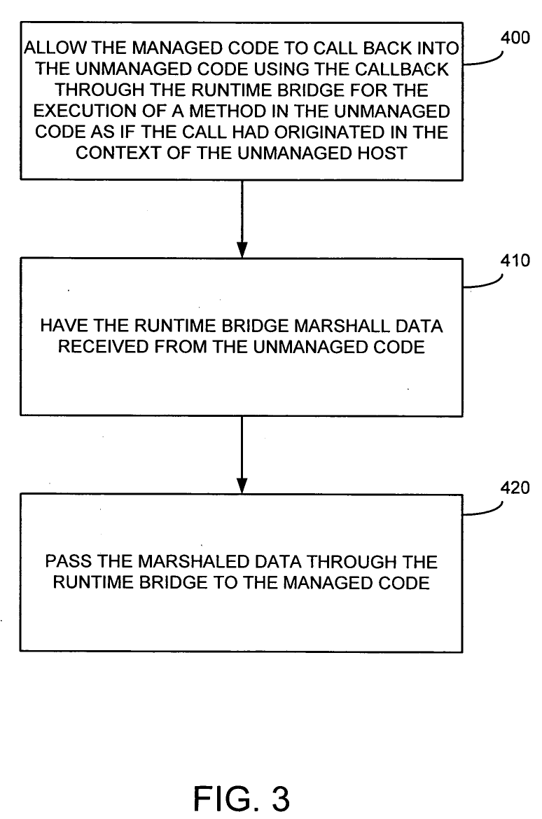

In addition, the managed code can call back into the unmanaged code using the callback through the runtime bridge for the execution of a method in the unmanaged code as if the call had originated in the context of the unmanaged host. FIG. 3 illustrates an example of one such method. At block 400, the managed code may be permitted to call back into the unmanaged code using the callback through the runtime bridge for the execution of a method in the unmanaged code as if the call had originated in the context of the unmanaged host. At block 410, the runtime bridge may marshal the data received from the unmanaged code. At block 420, the marshaled data may be passed through the runtime bridge to the managed code.

As an example, a piece of managed code may be called Mango and a piece of pre-existing unmanaged code may be called Unger. Unger may be a pre-existing accounts receivable system and Mango may be a piece of inventory management software that desires to use some of the features of Unger without having to entirely rewrite Unger into a managed code format.

The system may load a runtime bridge into Unger, the unmanaged host. A callback may be passed from Unger to the runtime bridge. The callback may be a callback to start an aspect of the Unger accounts receivable system, for example. Under direction of Unger, Mango may be loaded into the runtime bridge. The system may then perform reflection on the parts of Mango loaded into the runtime bridge. The system may then execute a method found in the loaded section of Mango in the runtime bridge, such as generating a report of the inventory of a certain item. The results of the call into Mango may then be passed to the runtime bridge. In this example, the results may be a report of the inventory of a certain item. The runtime bridge may marshal the results of the call into Mango into a form that would be understood be Unger. For example, Unger may require that the inventory data be in a certain format. The marshaled results may then be passed to Unger such that Unger can now use the results as if the call had started in Unger in the first instance. For example, if the Unger accounts receivable method indicated ten widgets had been sold, then the Mango inventory method should reduce the number of widgets in inventory by ten.

In addition, the Mango can call back into the Unger code using the callback through the runtime bridge for the execution of a method in Unger as if the call had originated in the context of Unger. The runtime bridge may marshal the data received from Unger and the marshaled data may be passed through the runtime bridge to Mango.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

1. A method of executing managed code in unmanaged host comprising;
loading a runtime bridge in the unmanaged host;
passing a callback from the unmanaged host to the runtime bridge;
loading specified managed code assembly into the runtime bridge (under direction of the unmanaged host);
executing a desired method found in the managed code assembly in the runtime bridge;
passing the results of the method called in the managed code assembly to the runtime bridge;
marshalling the results of the method called in the managed code assembly in the runtime bridge such that the results can be used by the unmanaged host; and
passing the marshaled results of the method called in the managed code assembly to the unmanaged host.

2. The method of claim 1, further comprising:
reflecting over the types in the managed code assembly in the runtime bridge;

3. The method of claim 2, further comprising:
instantiating classes found through reflection.

4. The method of claim 1, further comprising:
loading a common language routine in the runtime bridge

5. The method of claim 1, further comprising:
allowing the managed code to call back into the unmanaged code using the callback through the runtime bridge for the execution of a method in the unmanaged code as if the call had originated in the context of the unmanaged host;
having the runtime bridge marshal data received from the unmanaged code; and
passing the marshaled data through the runtime bridge to the managed code.

6. A memory having a computer program stored therein, said computer program being capable of being used in connection with a computing apparatus, said memory comprising:
a memory portion physically configured in accordance with computer program instructions that would cause the computing apparatus to load a runtime bridge in an unmanaged host;
an additional memory portion physically configured in accordance with computer program instructions that would cause the computing apparatus to pass a callback from the unmanaged host to the runtime bridge;
an additional memory portion physically configured in accordance with computer program instructions that would cause the computing apparatus to load specified managed code assembly into the runtime bridge (under direction of the unmanaged host);
an additional memory portion physically configured in accordance with computer program instructions that would cause the computing apparatus to execute a desired method found in the managed code assembly in the runtime bridge;
an additional memory portion physically configured in accordance with computer program instructions that would cause the computing apparatus to pass the results of the method called in the managed code assembly to the runtime bridge;
an additional memory portion physically configured in accordance with computer program instructions that would cause the computing apparatus to marshal the results of the method called in the managed code assembly in the runtime bridge such that the results can be used by the unmanaged host; and
an additional memory portion physically configured in accordance with computer program instructions that would cause the computing apparatus to pass the marshaled results of the method called in the managed code assembly to the unmanaged host.

7. The memory of claim 6, further comprising:
an additional memory portion physically configured in accordance with computer program instructions that would cause the computing apparatus to reflect over the types in the managed code assembly in the runtime bridge;

8. The memory of claim 7, further comprising:
an additional memory portion physically configured in accordance with computer program instructions that would cause the computing apparatus to instantiate classes found through reflection.

9. The memory of claim 6, further comprising:
an additional memory portion physically configured in accordance with computer program instructions that would cause the computing apparatus to load a common language routine in the runtime bridge

10. The memory of claim 6, further comprising:
an additional memory portion physically configured in accordance with computer program instructions that would cause the computing apparatus to allowing the managed code to call back into the unmanaged code using the callback through the runtime bridge for the execution of a method in the unmanaged code as if the call had originated in the context of the unmanaged host;
an additional memory portion physically configured in accordance with computer program instructions that would cause the computing apparatus to have the runtime bridge marshal data received from the unmanaged code; and
an additional memory portion physically configured in accordance with computer program instructions that would cause the computing apparatus to pass the marshaled data through the runtime bridge to the managed code.

11. A computing apparatus, comprising:
a display unit that is capable of generating video images;
an input device;
a processing apparatus operatively coupled to said display unit and said input device, said processing apparatus comprising a processor and a memory operatively coupled to said processor,
a network interface connected to a network and to the processing apparatus;
said processing apparatus being programmed to load a runtime bridge in the unmanaged host;
said processing apparatus being programmed to pass a callback from the unmanaged host to the runtime bridge;
said processing apparatus being programmed to load specified managed code assembly into the runtime bridge (under direction of the unmanaged host);
said processing apparatus being programmed to execute a desired method found in the managed code assembly in the runtime bridge;
said processing apparatus being programmed to pass the results of the method called in the managed code assembly to the runtime bridge;
said processing apparatus being programmed to marshal the results of the method called in the managed code assembly in the runtime bridge such that the results can be used by the unmanaged host; and
said processing apparatus being programmed to pass the marshaled results of the method called in the managed code assembly to the unmanaged host.

12. The computing apparatus of claim 11, further comprising:
said processing apparatus being programmed to reflect over the types in the managed code assembly in the runtime bridge;

13. The computing apparatus of claim 12, further comprising:
said processing apparatus being programmed to instantiate classes found through reflection.

14. The computing apparatus of claim 11, further comprising:
said processing apparatus being programmed to load a common language routine in the runtime bridge

15. The computing apparatus of claim 11, further comprising:
said processing apparatus being programmed to allow the managed code to call back into the unmanaged code using the callback through the runtime bridge for the execution of a method in the unmanaged code as if the call had originated in the context of the unmanaged host;
said processing apparatus being programmed to have the runtime bridge marshal data received from the unmanaged code; and
said processing apparatus being programmed to pass the marshaled data through the runtime bridge to the managed code.
